(19) United States
(12) Patent Application Publication
(10) Pub. No.: US 2025/0209442 A1
(43) Pub. Date: Jun. 26, 2025

(54) HANDHELD MOBILE PAYMENT PROCESSING SYSTEM AND CASE

(71) Applicant: Qorum, Inc., Los Angeles, CA (US)

(72) Inventors: Andrew PIETRA, Los Angeles, CA (US); Nicholas Ikaika CADIENTE, Los Angeles, CA (US)

(73) Assignee: Qorum, Inc., Los Angeles, CA (US)

(21) Appl. No.: 18/845,504

(22) PCT Filed: Aug. 1, 2022
(86) PCT No.: PCT/US2022/039064

§ 371 Date: Sep. 10, 2024

Related U.S. Application Data
(60) Provisional application No. 63/320,237, filed on Mar. 16, 2022.
(60) Provisional application No. 63/269,155, filed on Mar. 10, 2022.

(51) Int. Cl. G06Q 20/34; G06Q 30/0207

(52) U.S. Cl. CPC G06Q 20/353; G06Q 30/0224

(57) ABSTRACT

A handheld mobile payment device and a system for mobile payment processing are disclosed. An exemplary handheld mobile payment device includes a smart mobile device; a credit card reader; and a protective case surrounding the smart mobile device and the credit card reader, wherein the protective case includes a first charging port to charge the smart mobile device and a second charging port to charge the credit card reader. An exemplary system for mobile payment processing includes a handheld mobile payment device that interfaces with a remote service to collect order information; presents confirmation and tip information to a customer; and transmits payment information to a payment processor, where in the handheld mobile payment device is a smart device coupled to a mobile credit card reader and runs a software application on a commercially available mobile operating system.

### RELATED APPLICATION

This application claims priority to U.S. Provisional Application No. 63/320,237, filed Mar. 16, 2022, and U.S. Provisional Application No. 63/269,155, filed on Mar. 10, 2022, both of which are incorporated herein by reference in their entirety.

### TECHNICAL FIELD

The present disclosure relates to an electronic solution for ordering items and for cashless payment of checks and bills at restaurants, bars, festivals, airplanes, and similar vending establishments. The present disclosure also relates to a handheld mobile payment case for the electronic solution, which combines a smart mobile device and a credit card reader in a handheld mobile payment device such that both the smart mobile device and credit card reader can be easily recharged by placing the handheld mobile payment device into a base unit configured to receive the handheld mobile payment device. The base unit may be configured with mating charging devices for the smart mobile device and credit card reader. Embodiments of the present disclosure are applicable to, but not limited to, facilitating payments in restaurants, bars, food trucks, or other venues or locations where mobile payments are transacted.

### BACKGROUND

In a restaurant or bar, customers are typically presented with a bill at the conclusion of service, whereafter they present the venue staff (i.e., a waiter, bartender, or the like) with a credit card. The credit card is taken from the customer, run through a point-of-service sales machine, and returned to the customer with a printed receipt upon which the customer may add a gratuity. Some credit cards may not be EMV-compliant cards and are “swiped” at a terminal to read payment information, rather than being “dipped” or “tapped.”

In an improvement that exists in the prior art, a server may bring a mobile payment terminal to the table for scanning a customer's credit card rather than taking the credit card to a fixed payment terminal. The mobile payment terminal is typically a proprietary device that is separate from the mobile ordering device. Such existing mobile payment terminals are commercially available from various point of service payment vendors. These mobile payment terminals may be relatively large, i.e., too large to be carried by the server throughout the serving period, or proprietary in that they cannot be repaired or replaced by the restaurant if damaged by a fall, spill, or other malfunctions and accidents typical in a restaurant setting, and instead must be replaced by their manufacturer or providing vendor. In some situations, a server may utilize a slimmed down version of a mobile payment terminal through the use of a mobile card reader, which can acquire credit card information either by including a credit card dipper or including contactless payment hardware. The mobile card reader is less functional than a traditional mobile payment terminal but is smaller and more portable. The mobile card reader would typically transmit credit card information to a mobile ordering device which would also be employed for payment processing using an application linked to the mobile credit card reader.

The mobile ordering device, mobile payment terminal, and/or mobile card reader are battery powered. So, throughout the serving period or at the conclusion of a day, both the mobile ordering device and the mobile payment terminal (or mobile card reader) would typically have to be recharged by separately plugging each into an AC power terminal possibly via USB plug or other proprietary connection. Having to maintain two separate devices which must be separately charged presents numerous problems to a restaurant. First, a server must keep track of two devices and may not be able to easily locate the mobile payment terminal when needed. Second, a server may forget to charge the mobile ordering device or the mobile payment terminal at the end of a shift, thereby preventing the restaurant from efficiently processing orders and/or payments.

Thus, there exists a need for a single mobile device that can perform the role of both a mobile ordering device and a mobile payment terminal, including credit card reading functionality, in a housing arranged such that all components can be quickly and easily recharged at the same time. There also exists a need for an improved electronic solution for ordering items and making cashless payments using such improved mobile payment device that minimizes personal contact or allows convenient management of internal and external management systems.

### SUMMARY

For example, in one embodiment, a customer can pay a restaurant check with a typical credit card, but instead of the credit card being taken to a remote POS, the payment is processed via a handheld mobile payment device running an application such as the Outpay Venue App.

In another embodiment, a customer may open a tab at a venue using a credit card but close the tab via a handheld mobile payment device running an application such as the Outpay Venue App. After the tab has been opened, but before it has been closed, the customer can optionally view check information on a personal mobile device or on a venue's handheld mobile payment device such as the handheld mobile payment device. This tab can be closed by the customer's personal mobile device, via the venue's handheld mobile payment device, or automatically after a preset time of inactivity without the customer having to again present the payment method, such as if the customer otherwise forgets to close the tab. The handheld mobile payment device may be used at a central location in the venue or at tableside, and may include Wi-Fi communication functionality for secure transmission of credit card information. Alternatively or in addition, the handheld mobile payment device may have cellular communication functionality as a communication method for secure credit card information.

In another embodiment, a customer may pay for a cover charge via a handheld mobile payment device running an application such as the Outpay Venue App that accesses predetermined cover charges stored in a remote service.

In another embodiment, a customer may pay for items from a limited menu such as at a music festival using a handheld mobile payment device running an application such as the Outpay Venue App. Due to the possibility of connection issues, payment information can be stored locally for later transmission to a remote payment processor. In this embodiment, when payment is taken for a cover charge, the taking of payments via the handheld mobile payment device may permit the payments to immediately post to the venue's point of sales system.

In another embodiment, a customer may pay for items using a name and room number such as might be utilized in a hotel. An application such as the Outpay Venue App running on a handheld mobile payment device may interface with a property management system to confirm validity of the name and number provided and permit payment processing. In this embodiment, the taking of payments via the handheld mobile payment device may permit the payments to immediately post to the venue's point of sales system and any associated room-charge database system.

In another embodiment, a customer may be given the option of joining or contributing to a loyalty program run by the venue or a third party, thus permitting customer insights to be generated and targeted offers to be delivered to the customer.

### BRIEF DESCRIPTION OF THE DRAWINGS

So that those having ordinary skill in the art to which the disclosed system pertains will more readily understand how to make and use the same, reference may be had to the following drawings.

FIG. 1 is a view of a handheld mobile payment device, under an embodiment of the present disclosure.

FIG. 2 is a rear view of a handheld mobile payment device, under an embodiment of the present disclosure.

FIG. 3 is a bottom view of a handheld mobile payment device, under an embodiment of the present disclosure.

FIG. 4 is a top view of a handheld mobile payment device, under an embodiment of the present disclosure.

FIG. 5 is a flowchart of an embodiment of the present disclosure involving card payments via an application running on a handheld mobile payment device.

FIG. 6 is a flowchart of an embodiment of the present disclosure involving payments from a tab via an application running on a handheld mobile payment device.

FIG. 7 is a flowchart of an embodiment of the present disclosure facilitating cover charge payments.

FIG. 8 is a flowchart of an embodiment of the present disclosure facilitating quick payment of items from a limited menu.

FIG. 9 is a flowchart of an embodiment of the present disclosure for verifying room charge payments.

FIG. 10 is a flowchart of an embodiment of the present disclosure for enrolling in a loyalty program and generating customer insights from collected data.

Other systems, methods, and computer-readable media are also discussed herein.

### DETAILED DESCRIPTION

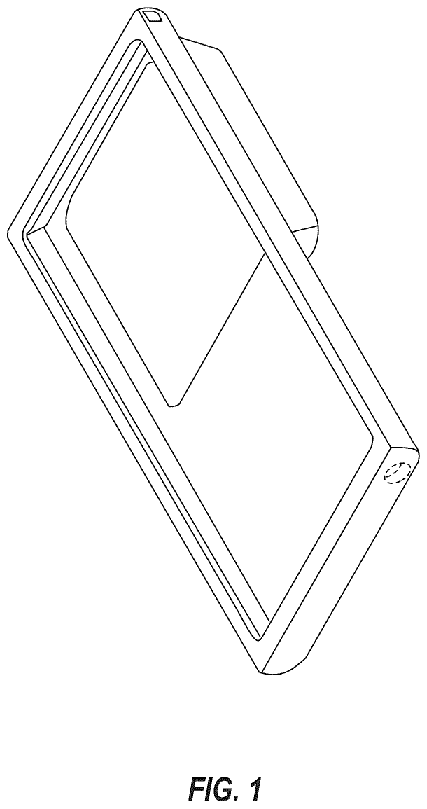

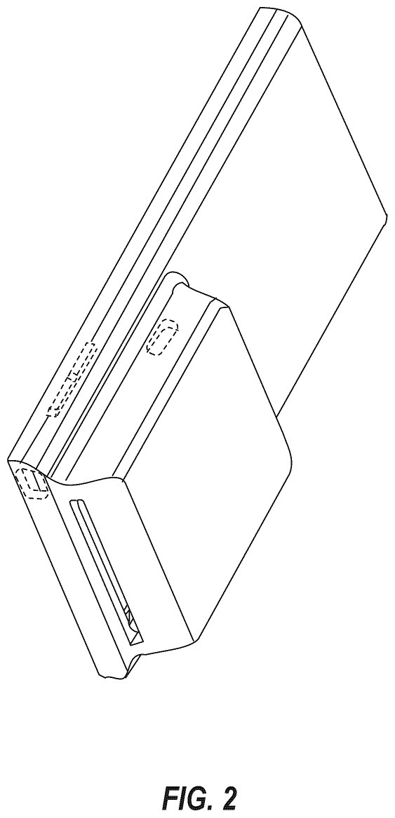

Embodiments of the handheld mobile payment device is described first with respect to FIGS. 1-4.

FIG. 1 depicts a handheld mobile payment device 100 which encloses both a mobile ordering device, such as a smart phone or a tablet, and a mobile credit card reader. In the arrangement shown in FIG. 1, the mobile credit card reader may be positioned within a case 101 such that it is held in a recess 102 directly behind a mobile ordering device location 103 but within the case 101. This arrangement may keep both the mobile ordering device and the mobile credit card reader together so that a server naturally carries both devices together as one unit. The handheld mobile payment device may be slim enough such that the unit can easily be carried in a server's pocket throughout their service window/period/shift.

FIG. 2 shows an alternate view of the handheld mobile payment device 100 wherein a slot 201 is visible. The slot 201 may be configured so that customers can insert a chip-enabled credit card for dip payments. The slot 201 may be intentionally arranged to permit only dip-style payments and prohibit swipe style payments. The case 101 may be made of an electromagnetically transparent material which also permits customers to pay for transactions using a touchless tap-to-pay transaction, wherein secure credit card information may be passed into the mobile credit card reader through the case 101 via a wireless communication. This arrangement may force customers to use touchless tap-to-pay or dip-style payments which are more secure and result in lower payment fees to the venue as compared with traditional swipe style payments.

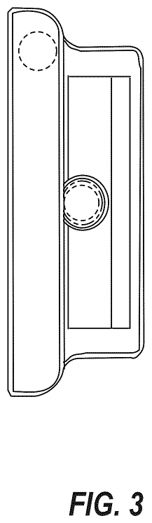

FIG. 3 shows a bottom view of the handheld mobile payment device, wherein the charge ports 301 and 302 for the mobile ordering device and the mobile credit card reader, respectively, can be seen. Charging of the two devices, i.e., the mobile ordering device and the mobile credit card reader, may be achieved by placing the handheld mobile payment device into a charging receiver base.

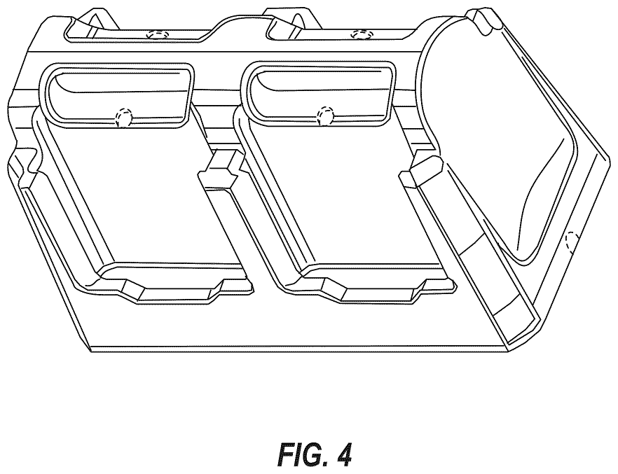

FIG. 4 shows an exemplary charging receiver base 400. The charging receiver base 400 may be arranged with a receiving component or cradle 401 into which the handheld mobile payment device 100 can be placed or docked by the server. The charging receiver base 400 may include flanges 402 to facilitate easy docking and repeatable alignment of the handheld mobile payment device 100 with chargers 403 when the handheld mobile payment device 100 is placed in the charging receiver base 400 (note the charger mating to the charge port 301 is not visible in FIG. 4).

In some embodiments, the receiving component or cradle 401 and flanges 402 may be contoured such that they provide mechanical guide for a handheld mobile payment device to slide therethrough. The charging receiver base 400 and the handheld mobile payment device 100 may each have a pair of magnetic USB charging adapters (not shown) that conveniently route power from the charging receiver base 400 into both the mobile ordering device and the mobile credit card reader. The magnetic USB charging adapters may feature a magnetically aligned disc coupler. The magnetically aligned discs may snap into place to complete the charging circuit when the coupling component on the handheld mobile payment device 100 comes in proximity to the coupling component on the charging receiver base 400.

Having two magnetic USB charging adapters on each handheld mobile payment device 100 mounted in the appropriate position to mate with the USB charger adapters on the charger receiver base 400 may allow the server to automatically set both the mobile ordering device and the mobile credit card reader into a charging state without having to fumble with one charging plug for the mobile ordering device and another plug for the mobile credit card reader, as with prior art systems.

Utilizing magnetic USB charging adapters may also facilitate easy charging of devices using disparate USB charging form factors. For example, typical mobile smart devices might utilize the USB-C charging standard, whereas typical mobile credit card readers might utilize the Micro USB charging standard. By utilizing magnetic USB adapters, the USB charging form factor appropriate for each component can be used to provide internal power to the corresponding components inside the handheld mobile payment device 100, but both components can use the same magnetically aligned USB charging coupler externally that the handheld mobile payment device 100 is configured to use. Standardizing the charging hardware may simplify the design of the charger base and may also permit additional flexibility of the internal components for the venue because any style device can be used within the handheld mobile payment device 100.

In another embodiment, a single USB charger can be used, configured in such a manner that power is supplied from the single USB charger to both the mobile ordering device and the mobile credit card reader. Still further, one or more inductive charging devices such as Qi charging coils can be used and configured in such a manner that power is supplied from the inductive charging devices to the mobile ordering device and the mobile credit card reader simultaneously. In either embodiments, power circuitry may be provided within the handheld mobile payment device 100 for routing power from the single USB charger to the mobile ordering device and the mobile credit card reader.

Combining the mobile ordering device and the mobile credit card reader into a single device within the handheld mobile payment device 100 may bring several advantages over prior art solutions. For example, because both the mobile ordering device and the mobile credit card reader may be commercially available components, the venue may be able to independently interchange, repair, or replace one or both of the components with off-the-shelf replacement parts rather than having to replace the entire unit. This may also increase device flexibility and reduce down time and costs when a device malfunctions due to being dropped, having liquid spilled upon it, or becomes out of commission for any other reason.

Having both components in a single handheld mobile payment device 100 and eliminating extraneous components may also allow for the overall device to be significantly smaller and more portable than prior art mobile payment terminals while bringing the functionality of mobile ordering. This reduction in size compared to prior art mobile payment terminals may allow for a server to carry the handheld mobile payment device on their person, potentially in a pocket, mounted to a belt, in a holster, or other carrying device. Combining both components into a single handheld mobile payment device 100 can also eliminate the need for expensive manufacturing costs otherwise associated with a device capable of both receiving mobile orders and receiving credit card information, thereby reducing upfront and long-run costs.

The handheld mobile payment device 100 can be manufactured of various materials including plastic or rubber. In some embodiments, the material should be permeable to wireless signals so as to allow mobile payment tap-to-pay transactions. Manufacturing the device from plastic or rubber may also provide additional benefits of bringing a degree of drop-protection to the device. Plastic or rubber may also make the device pliable enough so that a venue can replace either the mobile device or the mobile credit card reader without a tool or other machining. This may make it serviceable in a typical restaurant or other food service situation. The handheld mobile payment device 100 can be manufactured using typical manufacturing processes such as injection molding, or it can be additively manufactured to provide additional customization options to venues such as various color options or other decorative elements without departing from the spirit of the disclosed embodiments.

In a further embodiment, the charging receiver base 400 can be arranged to receive two, four, six or more of the handheld mobile payment devices. Note that FIG. 4 shows an embodiment receiving four. The charger receiver base 400 can also be modular so that a venue can add as many handheld mobile payment devices are necessary for service in the particular venue. The size of the charger receiver base 400 may be limited only by the quantity of magnetic USB charger adapters which can be expanded by providing additional power sources to the underside of the charger receiver or by utilizing USB splitter devices.

In an alternative embodiment, rather than using magnetically aligned USB chargers, the handheld mobile payment device 100 can charge the smart mobile device and credit card reader through an inductive charging device mounted on the back of the handheld mobile payment device 100. The handheld mobile payment device 100 would include power circuitry sufficient to route power from the inductive charging device to both the smart mobile device and the mobile credit card reader. In this embodiment, the handheld mobile payment device 100 may not have openings for the dedicated charging ports for the smart mobile device or the mobile credit card reader. Such configuration may offer additional water resistance, or near waterproofness, functionality compared to the embodiment having openings for charging ports.

In an alternative embodiment, the handheld mobile payment device 100 may utilize built in inductive charging functionality of the smart mobile device to provide power to the mobile credit card reader.

In an alternative embodiment, USB power can be provided to the charging receiver base 400 not by traditional mains AC power, but instead by a car battery, power tool battery, generator, external battery pack, providing greater flexibility to the venue including potentially charging the handheld mobile payment devices 100 at music festivals where mains power may not be readily available. Additionally or alternatively, the charging receiver base 400 may comprise one or more batteries. The batteries may allow the charger base to operate even when another power source is unavailable. The batteries may comprise any one or a combination of custom array of battery cells, off-the-shelf disposable batteries, or off-the-shelf rechargeable batteries.

In some embodiments, the charging receiver base 400 may comprise wireless networking components that can serve as a Wi-Fi hotspot or a router. For example, the charging receiver base 400 may comprise components that allow the charging receiver base 400 to connect to the Internet via cellular connections (e.g., LTE or 5G) and allow other devices nearby to connect to the Internet through the charging receiver base 400. The charging receiver base 400 may selectively allow certain devices such as the handheld mobile payment devices 100 to connect to the Internet or allow all WiFi-capable devices such as laptops or other mobile devices to connect to the Internet. In further embodiments, the charging receiver base 400 may comprise cryptocurrency miners or allow standalone cryptocurrency miners to connect to the Internet. Such capability may allow the charging receiver base 400 to mine cryptocurrency using the Internet connection.

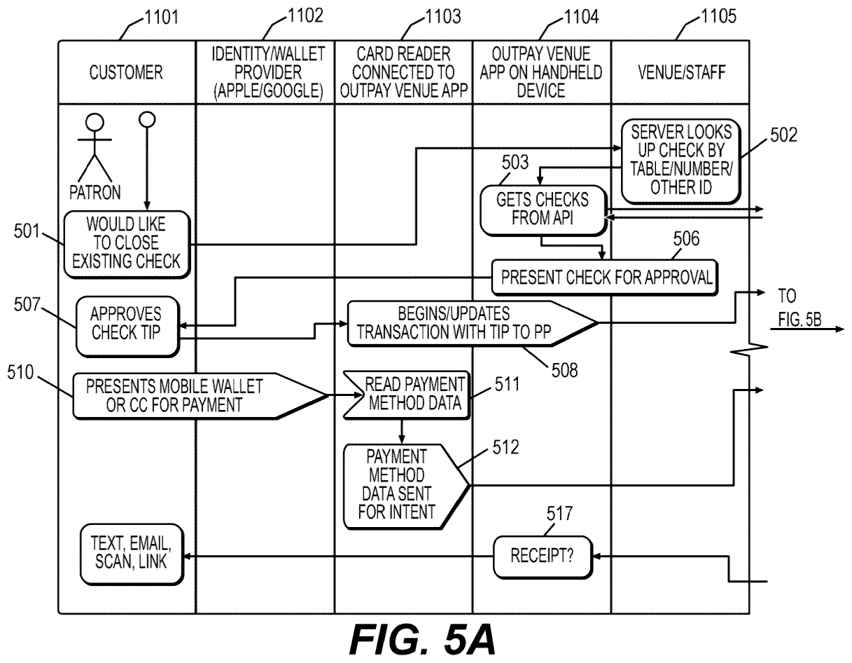

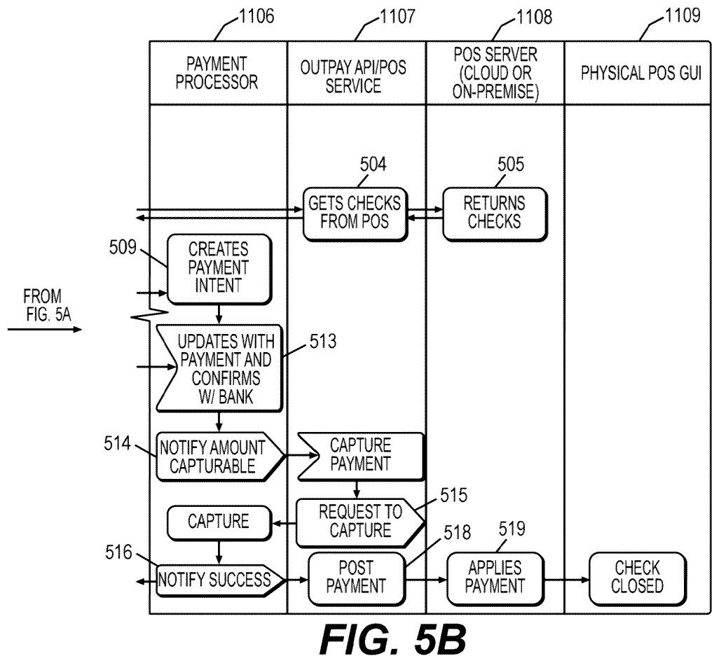

FIGS. 5A and 5B depict a flow chart of an embodiment of the present disclosure in which payment can be made for an existing check created with a traditional point of sales system in a manner that utilizes an application such as the Outpay App on a mobile handheld payment device that combines a mobile ordering device with a credit card reader, as described above. In a situation consistent with this embodiment, a customer 1101 first seeks, at step 501, to close an existing check at a venue that has been created using a traditional point of sales (POS) system. A venue staff 1105 uses a handheld mobile payment device 1104 running an application such as the Outpay App. Using the handheld mobile payment device 1104, the venue staff 1105 looks up, at step 502, the customer's check using a table number or other identifier. This look up operation correlates the items ordered by the customer and their table. Using the handheld mobile payment device 1104, the venue staff's inquiry causes a request to be sent via an application programming interface (API), at step 503, into a remote service such as an Outpay server 1107 or a remote POS service. The Outpay server 1107 or the POS service would query and return the check information correlated to the table number or other identifier used by the venue staff 1105 at steps 504 and 505.

The check information would be presented on the handheld mobile payment device 1104 and presented to the customer for approval at step 506. At this point, the handheld mobile payment device 1104 may also calculate potential tip amounts (e.g., 15%, 20%, 25%) and the handheld mobile payment device 1104 would be presented to the customer for approval. After the customer has approved the tip amount at step 507, the check is updated to include the intended tip amount, at step 508, and a payment processor 1106 such as Stripe is informed of an intended payment at step 509.

At this point the handheld mobile payment device 1104 is presented to the customer so that the customer can present payment either via mobile wallet 1102 (such as Apple Pay or Google Pay) or via a physical credit card at step 510. A credit card reader 1103 connected to the handheld mobile payment device 1104 may receive credit card information via chip/dip payment or via touchless payment at step 511. The credit card information is passed to an application such as the Outpay Venue App running on the handheld mobile payment device 1104, wherein the credit card information is sent securely, at step 512, to the payment processor 1106 such as Stripe via the payment processor's Software Development Kit (SDK). At step 513, the payment processor associates the credit card information with the payment information and confirms, authorizes, or holds that amount on the card, effectively confirming the payment transaction with the customer's bank records. The payment processor 1106 is notified of the amount capturable for the transaction at 514 and passes this information to a remote service such as the Outpay API 1107 via webhook, indicating that the amount is ready to be captured. At step 515, Outpay API 1107 or the POS service creates a request to capture payment which is transmitted back to the payment processor. The request for payment capture can be made immediately when receiving the notice of readiness, or can be processed at a later time such as end of day, in case a refund may need to be processed.

If the capture request is successful, the payment processor 1106 notifies the Outpay backend, at step 516, which sends payment to a POS server 1108, thereby updating the POS on the transaction. A receipt can be sent to the customer 1101, at step 517, via an application on the mobile handheld payment device 1104 such as the Outpay Venue App and a record of the successful payment is posted, at step 518, to the remote service such as the Outpay API 1107 or the POS service. The Outpay API 1107 or the POS server applies the payment to the check, at step 519, which is reflected in the physical POS graphical user interface (GUI) 1109.

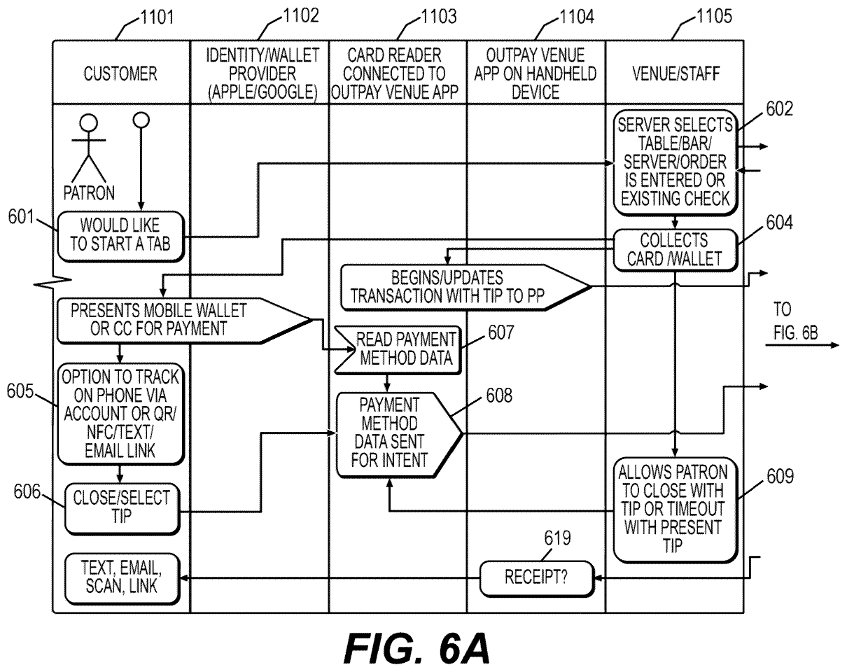

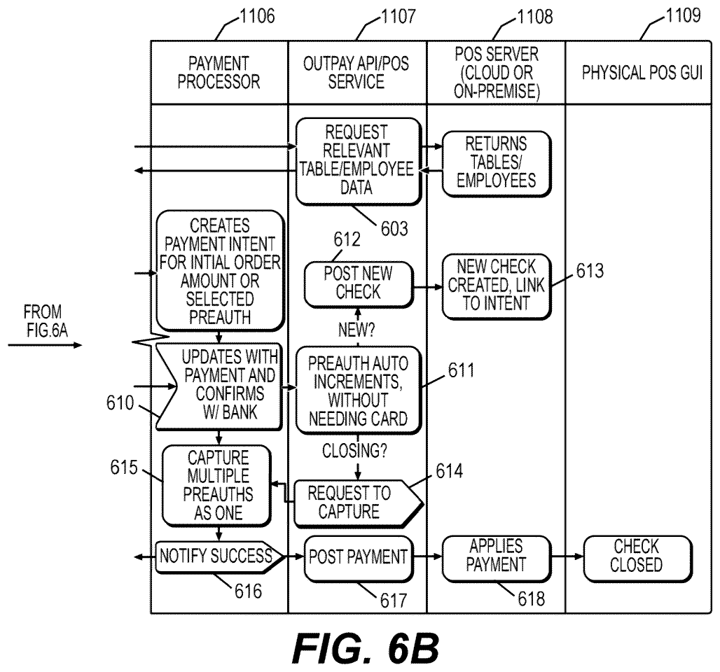

FIGS. 6A and 6B depict a flow chart of an embodiment of the present disclosure in which a customer opens a tab for ordering items at a restaurant or bar. In this embodiment, a customer 1101 requests to start a tab, at step 601 for ordering items and presents a physical credit card to venue staff 1105. The venue staff 1105 utilizes a remote service such as the Outpay API 1107 or the POS service, at step 602, to determine whether the customer already has an open check and whether the check has been assigned to a particular table or venue staff 1105. The remote service such as the Outpay API 1107 or the POS service will query a POS server or Outpay server 1108, at step 603, to determine whether the check has been assigned to a table or venue staff. If the check has not been assigned to a table or venue staff, the venue staff 1105 can make the appropriate assignment.

At step 604, the venue staff 1105 will then collect payment using the credit card or potentially a mobile wallet from the customer. The customer 1101 has the option of utilizing an application on a smart device such as the Outpay app to associate a payment method with the check and track the orders assigned to their tab at step 605. When the customer has finished ordering items, they have several options to close the tab and select a tip amount.

In a first option, at step 606, the customer may use the application such as the Outpay app on their smart device, without directly informing the venue staff. In a second option, if the customer chooses not to close the tab via the application on their own smart device, they may alternatively close the tab, at step 607, using a credit card reader 1103 connected to an application such as the Outpay Venue app running on a handheld mobile payment device 1104. In that option, the customer can close the check and associate a desired tip amount. Closing the tab via the handheld mobile payment device will inform the payment processor 1106 to create a payment intent, at step 608, for the initial order amount or in some cases a selected preauthorization amount. In a third option, the customer may forget to inform the venue staff of an intent to close the tab and may also forget to affirmatively close the tab on their smart device via the application such as the Outpay app. In this case, the venue staff 1105 can close the check using a preselected tip amount, at step 609, via an application such as the Outpay Venue app running on a handheld mobile payment device 1104.

In all instances, when the check or tab is closed, payment data will be sent to a payment processor 1106 which updates the payment information and makes appropriate confirmation with the customer's bank at step 610. Before the check is closed, the payment processor can communicate with a remote service such as the Outpay API 1107 or the POS service, at step 611, to automatically create a preauthorization amount or increase preauthorization amounts incrementally without needing the credit card again.

If the tab is being opened, the remote service such as the Outpay API 1107 or the POS service will post a new check at step 612 and create a new check at step 613 in the POS server 1108 that is linked to the payment intent. If the tab is being closed, a request to capture the payment information will be transmitted to the payment processor 1106 at step 614. The payment processor 1106 will capture the potentially numerous preauthorization amounts as a single payment at step 615 and notify the remote service such as the Outpay API 1107 or the POS service of the successful payment transaction at step 616. At this point, the remote service such as the Outpay API 1107 or the POS service will post the payment at step 617, cause the POS server 1108 to apply the payment to the check at step 618, and indicate via a GUI 1109 on the physical POS that the check has been closed. At step 619, the payment processor may also cause a receipt to be sent from an application such as the Outpay App running on the handheld mobile payment device 1104 to the customer 1101 via text, email, or other method.

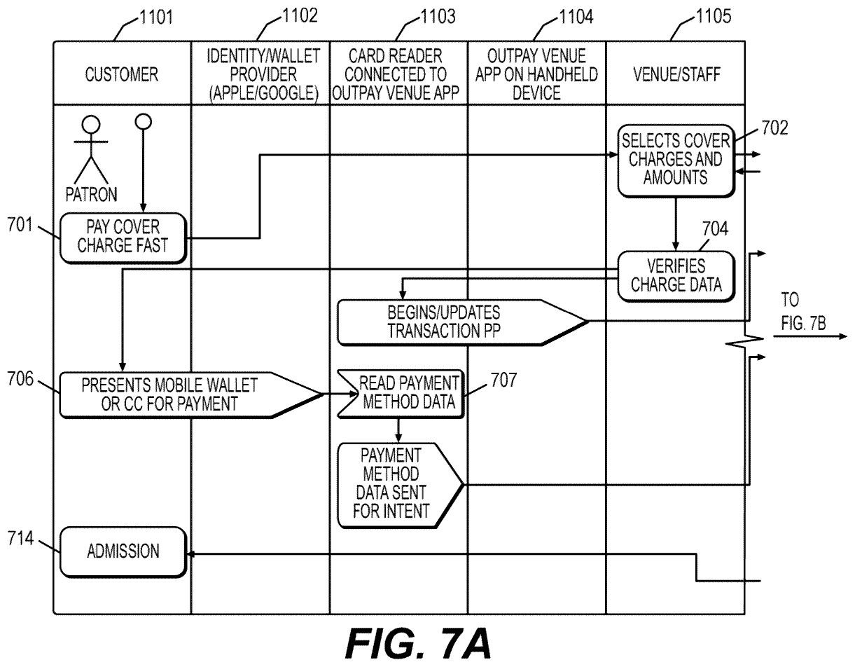

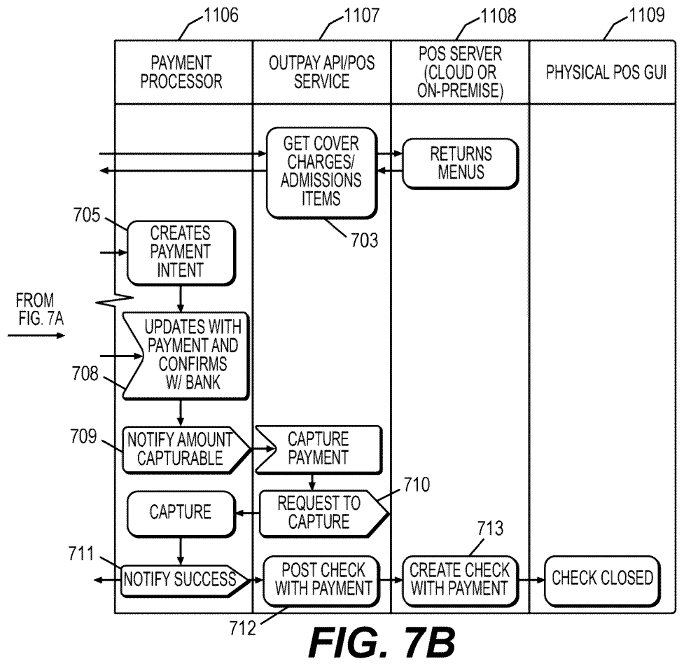

FIGS. 7A and 7B depict an embodiment of the present disclosure utilized to facilitate the payment of cover charges, or other similar admission charges, that might be charged as customers enter a bar, club, or other establishment. In this embodiment, at step 701, the customer 1101, seeks to pay a cover charge. The venue staff 1105, preselects cover charges and amounts, at step 702, potentially interfacing with a remote service such as the Outpay API 1107 or a POS service which itself interacts with a POS server 1108, at step 703, to determine a menu of potential cover charges or other admission items. The venue staff 1105 verifies the charge data at step 704, i.e., the number of patrons requesting to pay the cover charge in a transaction, and begins a transaction via the payment processor 1106. The payment processor 1106 creates a payment intent at step 705 upon receiving transaction information from the handheld mobile payment device 1104 running an application such as the Outpay Venue App. The customer 1101 has the option, at step 706, to present a credit card for payment or to present a mobile wallet 1102 such as Apple Pay or Google Pay for payment.

Utilizing the handheld mobile payment device 1104, the venue staff 1105 acquires payment method data at step 707 and sends the payment method data to the payment processor which associates the payment intent with the payment information and confirms payment with the customer's bank at step 708. At step 709, the payment processor 1106 notifies the amount capturable to a remote service such as the Outpay API 1107 or the POS service. The remote service such as the Outpay API 1107 or the POS Service sends a request to capture to the payment processor 1106 at step 710, which captures payment and returns a notification of success to the remote service such as the Outpay API 1107 or the POS Service at step 711. The remote service such as the Outpay API 1107 or the POS Service posts the check with payment to the POS server 1108 at step 712, which creates a check associated with the payment at step 713 and indicates that it has been closed. The customer 1101 is also informed of the successful transaction by receiving a receipt for payment via email or text and being admitted to the venue at step 714.

In this embodiment, cover charges processing may be expedited significantly compared to credit card processing in prior art solutions, because checks are opened, paid, and closed immediately and cover charge amounts are preloaded into the handheld mobile payment device 1104 running an application such as the Outpay Venue App. The payment processing also skips the tip amount and confirmation step, further expediting payment processing.

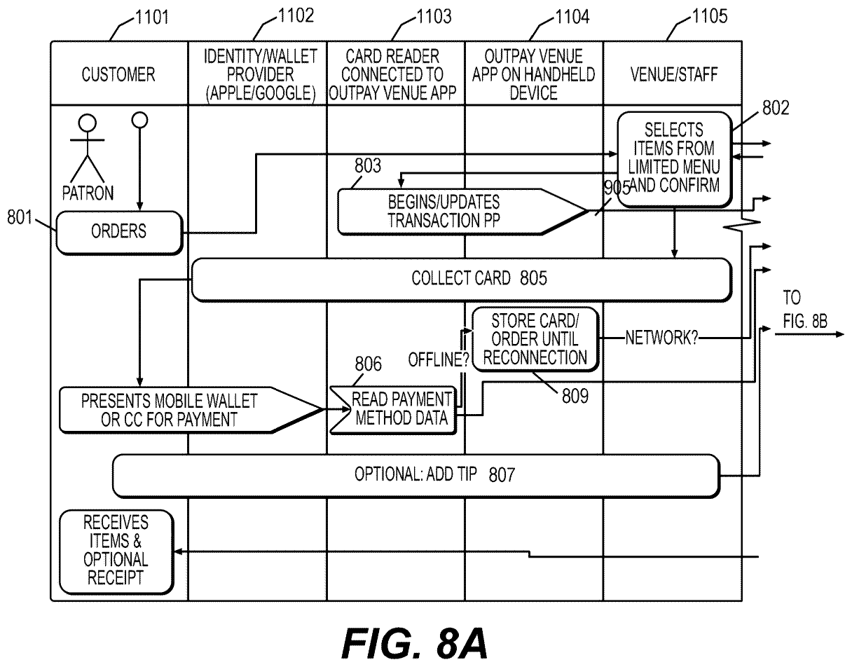

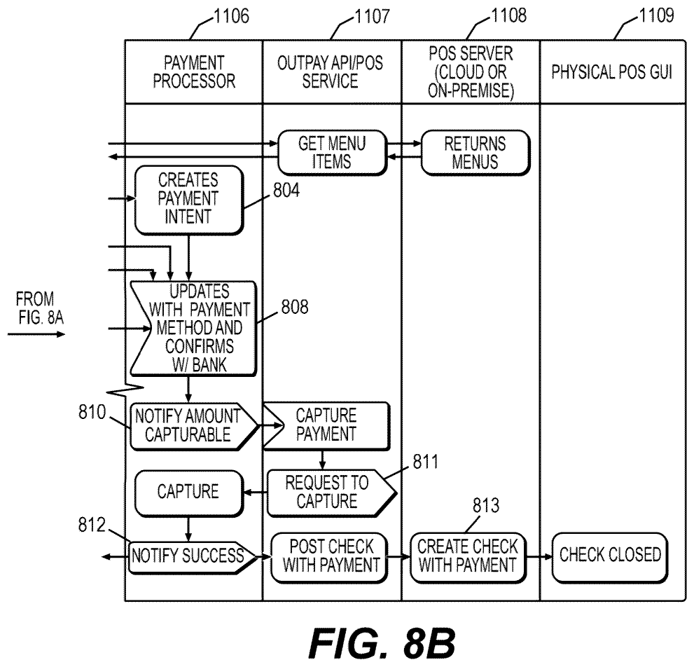

FIGS. 8A and 8B depict an embodiment of the present disclosure to facilitate quick ordering of items from a limited menu, such as items from a food or drink vendor at a music festival, golf course, airline, bottle service, side cart, bar cart, cocktail venue, or food truck. In this embodiment, the customer 1101 desires to place an order at step 801. At step 802, the venue staff 1105 preselects items from a limited menu which may be drawn from a list of menu items available via a remote service such as the Outpay API 1107 or POS Service from a POS Server 1108 which stores menus. The venue staff confirms the selections from the customer and begins a transaction with the payment processor 1106 at step 803. In this embodiment, payment may be associated with items ordered rather than with an existing check.

The payment processor 1106 creates a payment intent at step 804 after receiving notification from a card reader 1103 connected to an application such as the Outpay Venue App running on the handheld mobile payment device 1104. The venue staff 1105 collects card information from the customer, at step 805, potentially via a mobile wallet 1102 such as Apple Pay or Google Pay or by collecting a physical credit card from the card reader 1103 connected to the handheld mobile payment device 1104 running an app such as the Outpay Venue App. The card reader 1103 receives payment method data at step 806. At step 807, the customer 1101 has the option to add a tip via the handheld mobile payment device 1104 running an app such as the Outpay Venue App.

If the venue has mobile connectivity, the payment and potential tip information would be transmitted promptly to the payment processor 1106, which will update the payment method based on the credit card transaction type and confirm with the bank at step 808. If the venue has limited connectivity, credit card and order information can be stored at step 809 until the handheld mobile payment device 1104 regains connectivity to transmit payment information to the payment processor 1106. When the payment processor 1106 receives payment information, it will notify the amount capturable, at step 810, to a remote service such as the Outpay API 1107 or POS Service which will indicate a request to capture payment to the payment processor 1106 at step 811. In this embodiment, when the Outpay Venue App receives notice of an amount capturable, a check may be created and payment applied. The payment processor 1106 will capture payment and return a notification of success, at step 812, which will trigger a receipt to the customer via email or text and will trigger a notification to the remote service such as the Outpay API 1107 or POS service that a check can be posted with payment. At step 813, the POS server 1108 will create the check associated with the payment and indicate visually on the POS GUI 1109 that the check has been closed.

This embodiment improves over prior art payment solutions for cover or admission charges where venue staff 1105 must, for each transaction, create a check, navigate through POS GUI elements to admission charges, send charges to a check, navigate to a payment section of a POS GUI 1109, select the type of charge, enter the amount of charges, select a tip (or typically skip a tip for cover charges), process payment, close a check, run a card, and optionally provide a receipt to the customer. In the present embodiment, the venue staff 1105 may simply select the quantity of admission charges and collect payment, optionally providing a receipt to the customer. The Outpay Venue app may automatically handle other aspects of the transaction without further interaction from the venue staff 1105, thereby freeing the venue staff 1105 to process additional transactions.

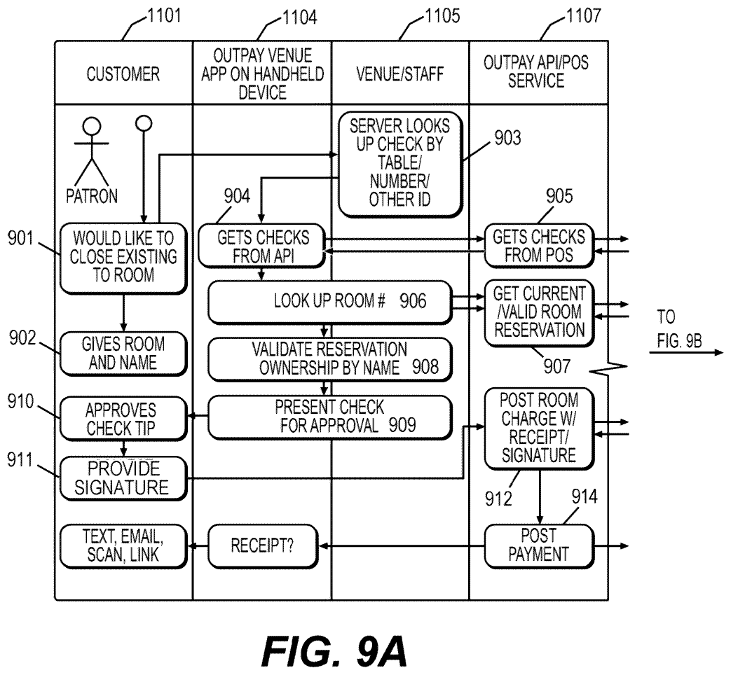

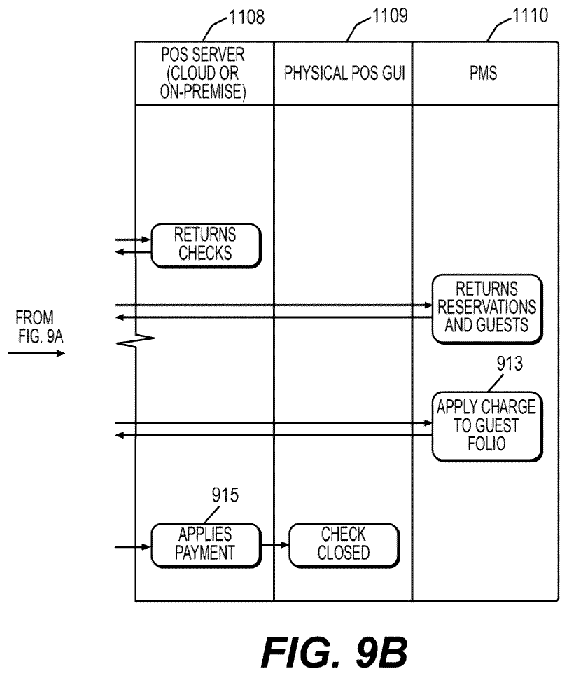

FIGS. 9A and 9B depict an embodiment of the present disclosure to facilitate room charges such as by a guest at a hotel and to link a property management service (PMS) 1110 with the point of sale tableside using an application such as the Outpay Venue App running on a handheld mobile payment device 1104. In this embodiment, a customer 1101 intends to close a check or tab to a room charge at a hotel or similar establishment, at step 901, and provides their room number and name, at step 902, to the venue staff 1105. At step 903, the venue staff 1105 looks up the check by table, check number, or other identifier.

In doing so, the venue staff 1105 can utilize handheld mobile payment device 1104 running an application such as the Outpay Venue App. The application checks a remote service such as the Outpay API 1107 or POS service, at step 904, to obtain check numbers. The remote service such as the Outpay API 1107 or POS service queries the POS server 1108 for check information at step 905. The venue staff 1105 can then utilize the handheld mobile payment device 1104 running an app such as the Outpay Venue App, at step 906, to look up the room number presented by the customer. The application will query a remote service such as the Outpay API 1107 or POS Service, at step 907, to determine whether the presented room number is associated with a current and valid room reservation.

In doing so, the remote service such as the Outpay API 1107 or POS service can interface with the PMS 1110 to determine the current and valid status of the room number and its association with the name presented by the customer at step 908. If the room number and name are confirmed, application on the handheld mobile payment device 1104 can present a check to the customer for approval at step 909. The customer can approve the check items and apply an appropriate tip, at step 910, and, if required, provide a signature for verification at step 911. The application on the handheld mobile payment device 1104 can transmit the payment information and signature verification to a remote service such as the Outpay API 1107, PMS 1110, and/or POS API at step 912. In this manner a charge can be added to the guest folio via the PMS API, at step 913, which could include a signature confirmation. Similarly, payment confirmation can be provided to the POS API including a tender type indicating that the payment had been applied as a room charge.

Additionally or alternatively, the customer 1101 may intend to add a new room charge to an existing check or tab without paying or closing the transaction. In such embodiments, the venue staff 1105 can look up the check by table, check number, or other identifier using the handheld mobile payment device 1104 connected to the remote service. The remote service such as the Outpay API 1107 or POS service can interface with the PMS 1110 to confirm the room number and check information as described above, in which case the new room charge can be added to the confirmed check information. In contrast to the previous embodiment, however, the remote service such as the Outpay API 1107 or POS service may leave the check open for additional room charges without presenting the check to the customer 1101 for payment.

In either embodiments, a charge can be added with one or more modifiers or comments, which can be forwarded to an appropriate department or system for further processing. For example, a charge for a food item may be modified with one or more special requests (e.g., extra tomato, or no peanut sauce) and forwarded to a kitchen for fulfillment. This example charge can also be forwarded to inventory management system to update inventory (e.g., record that an extra tomato was used) or trigger automatic stock replenishment.

Turning back to payment processing, at step 914, the remote service such as the Outpay API 1107 or the POS service posts payment as a room charge with receipt and signature. The POS server 1108 will in turn apply the payment to the transaction at step 915 and indicate on the physical POS GUI 1109 that the check has been closed. A receipt for the transaction can also be sent to the customer via email, text, or other method.

Alternatively or additionally, the venue staff 1105 can utilize an existing application on the physical POS GUI 1109 to interact with the PMS 1110. In such embodiments, the functionalities described above with respect to the remote service such as the Outpay Venue App 1107 or the POS service can be achieved via previously established connections between the physical POS GUI 1109 and the PMS 1110. Still further, the venue staff 1105 can interact with the PMS 1110 directly by utilizing a client application interfacing with the PMS 1110, for maximum adjustability using a native application.

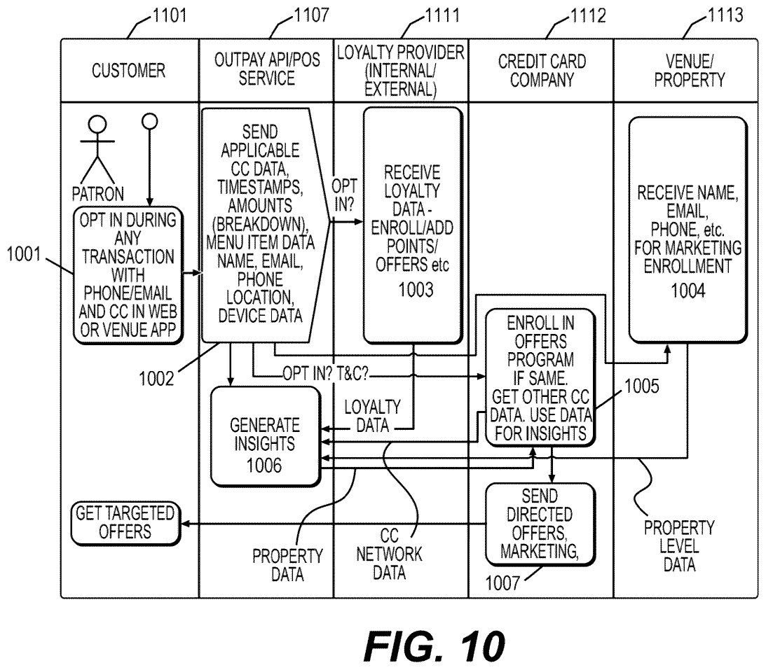

In further embodiments, each venue staff 1105 can be assigned a unique identifier number (e.g., PIN), which the Outpay Venue App running on the handheld mobile payment device 1104 may require before the venue staff 1105 enters a charge or any other action (e.g., opening a check, collecting payment, etc.) with respect to a customer. In this way, a charge or any action can be associated with a specific employee login account to act as designated personnel or responsible party, which can facilitate subsequent processing such as distributing tips, filtering actions by employee, auditing, or the like. FIG. 10 depicts an embodiment of the present disclosure wherein a customer can opt in to a venue or company's loyalty program during any part of the transaction. This aspect of the present disclosure can be layered on top of other embodiments described in the foregoing specification.

In this embodiment, the customer 1101 is given the option to opt-in using their phone, email, and/or credit card information to a loyalty program at step 1001. The remote service such as the Outpay API 1107 or POS service can send customer information such as applicable credit card information, time stamps, transaction amounts, transaction items ordered, menu item data, name, email, phone, location, IP addresses, device data, and/or other information to a loyalty provider 1111 at step 1002. At step 1003, the loyalty provider 1111, which may be internal or external to the venue 1113, receives the customer information and can enroll the customer in a potential loyalty program, add points or frequent-purchaser information, and generate potential discounts or other offers to the customer based on the received customer information. At step 1004, the venue 1113 or property itself may also receive all or a subset of the customer information for enrollment in its own marketing programs. At step 1005, the customer information may also be sent to a credit card company 1112, airline, hotel, restaurant, rideshare, bank, or application such as Outpay, for enrollment in that company's own loyalty program.

All customer information along with loyalty data from the loyalty provider 1111, potential credit card network data, and property level data, can be fed into appropriate data analytics programs at step 1006 to generate insights about likely or potential purchasing habits. Customer insights can include generation of dynamic menu option for customers 1101 based on prior orders, review, ratings, venues, and customer behaviors. Insights can identify high value customers by card, loyalty level, or account information and provide information about such customers to venue staff 1105 utilizing a handheld mobile payment device 1104 running an application such as the Outpay Venue app.

These insights can further be provided to the credit card company 1112, venue 1113, or other recipient, in order to send directed offers and other marketing material to the customer 1101 in the form of targeted offers at step 1007. Directed offers may include discounts or free rides on a ridesharing service, free or discounted items including drinks or food, free marketing items, or exclusive access to events or spaces, badges, points or non-fungible tokens. Directed offers can be customized by advertisers or venues 1113 to include customized food menus, video or static advertisements, billboards, etc., based on past spending behavior known to mobile apps such as Outpay, loyalty program enrollment and/or status, and/or card spend based on past credit card transactions and behaviors. In another embodiment, customer data can be exchanged to, from, and between customer information databases maintained by the venue 1113, credit card company 1112, credit bureau, and/or Outpay itself in order to facilitate further insights into customer purchasing habits.

In the above-described embodiments, use of the handheld mobile payment device 1104 further improves over prior art solutions because it permits multiple payment and ordering activities to occur on a single instance of a traditional point of sale terminal, or potentially no traditional point of sale terminal at all if all transactions are handled via the Outpay API 1107 in the cloud.

The disclosed embodiments may afford users (i.e., managers of a venue interested in obtaining payments from customers) a greater flexibility in interfacing conventional POS and PMS 1110. Existing POS services are often locked to a specific PMS or have limited interoperability with third party services or systems, thus forcing users to compromise on functionality and/or ease of use. For example, many existing POS and PMS are often problematic, unintuitive, or bulky. Some even do not offer any tableside hardware or interoperability with electronic payment processing systems.

As discussed above with respect to the figures, the disclosed embodiments may thus provide hardware and software solutions that pair previously incompatible POS and PMS combinations with user-friendly tableside workflows. In the prior art, the POS and PMS systems were tightly coupled via proprietary solutions from vendors such as the Oracle Simphony POS or the Oracle OPERA PMS). These proprietary systems provided for controlled exchange of information from POS to PMS such as transmitting room charges. This integration and lack of extensibility forces venues into using potentially problematic, unintuitive, bulky, and/or non-existent tableside mobile payment device hardware, or may have required venues to manually store receipts for later data entry. In contrast, the disclosed embodiments may provide an interaction layer that sits between a proprietary POS from one vendor (Simphony POS by Oracle) and a proprietary PMS from another vendor (Payments PMS by Stripe), thereby allowing the two proprietary systems to be used together at a single venue.

Furthermore, the interaction layer may permit new or improved intermediate hardware and processing functionalities on and via a handheld mobile payment device 1104 that were previously unavailable with proprietary POS and PMS systems. For example, the interaction layer, together with the disclosed embodiments, eliminate or substantially reduce manual processes that venue staffs 1105 and customers 1101 had to go through when using prior art systems (e.g., printing out an invoice, receiving credit card from a customer for payment, authorizing a payment using the credit card, printing out a receipt, receiving signature and/or tip from the customer, etc.). The interaction layer can also communicate with either the POS server 1108 or the PMS 1110 to obtain customer information for different use case scenarios (e.g., looking up/validating rooms, creating room charges, using property discounts, earning or using loyalty points, etc.). Such reductions significantly lower the complexity of in-person transactions, resulting in improved user experience and faster service.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A handheld mobile payment device comprising:
a smart mobile device;
a credit card reader; and
a protective case surrounding said smart mobile device and said credit card reader, wherein:
said protective case includes a first charging port to charge said smart mobile device and a second charging port to charge said credit card reader.

2. The handheld mobile payment device of claim 1 wherein the charging ports are provided by magnetically aligned USB charging adapters.

3. The handheld mobile payment device of claim 1 wherein the smart mobile device is a smartphone.

4. The handheld mobile payment device of claim 1 wherein the smart mobile device is a tablet.

5. The handheld mobile payment device of claim 1 wherein a user is able to separately replace the smart mobile device or the credit card reader.

6. The handheld mobile payment device of claim 1 wherein the credit card reader does not permit swipe credit card payments.

7. A handheld mobile payment device comprising:
a smart mobile device;
a credit card reader; and
a protective case surrounding said smart mobile device and said credit card reader, wherein:
the protective case includes an inductive charging member that provides power to the smart mobile device and the credit card reader.

8. A system for mobile payment processing wherein:
a customer presents a payment information to a handheld mobile payment device,
the handheld mobile payment device interfaces with a remote service to collect order information,
the handheld mobile payment device presents confirmation and tip information to a customer, and
the handheld mobile payment device transmits payment information to a payment processor,
wherein the handheld mobile payment device:
is a smart device coupled to a mobile credit card reader, and
runs a software application on a commercially available mobile operating system.

9. The system of claim 8, wherein the payment information comprises information related to a physical credit card.

10. The system of claim 8, wherein the payment information comprises information from a mobile wallet.

11. The system of claim 8, wherein
the payment information comprises a room number and name,
the handheld mobile payment device interfaces with a property management system, and
the property management system verifies that the room number and name are valid and current.

12. The system of claim 8, wherein payment information is stored locally for transmission to a payment processor at a time substantially after the time of ordering.

13. The system of claim 8, wherein:
a tab is opened for the customer,
incremental preauthorization is made as the customer orders items, and
the customer can track items that have been ordered via a smart device.

14. The system of claim 8, wherein:
the handheld mobile payment device is also utilized to take orders for items from customers.

15. The system of claim 13, wherein the tab is closed by a customer through their smart device.

16. The system of claim 13, wherein the tab is closed via a handheld mobile payment device.

17. The system of claim 13, wherein the tab is closed after a time period of inactivity has elapsed.

18. The system of claim 8, wherein
customer information is provided to a loyalty program,
customer insights are generated based on customer buying information associated with said loyalty program, and
directed offers are provided to the customer based on the customer insights.

19. A system for mobile payment processing of cover charges wherein:
a cover charge amount is predetermined and stored in a remote server,
a customer presents payment information for payment of said cover charge amount,
said payment information is received via a handheld mobile payment device for transmission to a payment processor.
